(19) United States
(12) Patent Application Publication
(10) Pub. No.: US 2026/0158421 A1
(43) Pub. Date: Jun. 11, 2026

(54) COMPONENT FOR A FILTER UNIT, FILTER UNIT, AND AIR PURIFICATION SYSTEM

(71) Applicant: Carl Freudenberg KG, Weinheim (DE)

(72) Inventors: Stefan KLUCK, Rheinmünster (DE); Sascha SCHUMACHER, Wald-Michelbach (DE)

(21) Appl. No.: 19/414,497

(22) Filed: Dec. 10, 2025

(30) Foreign Application Priority Data
Dec. 11, 2024 (DE) 10 2024 137 231.1

(51) Int. Cl. B01D 29/64

(52) U.S. Cl. CPC B01D 29/6438; B01D 2201/081

(57) ABSTRACT

A component for a filter unit includes a nozzle element having a first diameter adjacent the filter unit, where the nozzle element has a second diameter, the second diameter being larger than the first diameter so that a resistance to an air flow from the filter unit is reduced by the nozzle element. The component for the filter unit includes an air-guide element configured to at least partially accelerate an air pulse into the filter unit in order to increase a cleaning performance in the filter unit.

### CROSS REFERENCE TO RELATED APPLICATIONS

This application claims benefit to German Patent Application No. DE 10 2024 137 231.1, filed on Dec. 11, 2024, which is hereby incorporated by reference herein.

### FIELD

The present invention relates to a component for a filter unit, a filter unit, and an air purification system.

### BACKGROUND

There are currently a wide variety of different approaches for designing air-conveying components of filter assemblies. Due to the increasing variety of air filter concepts in the field of air purification systems and the increased quality and performance requirements, there is a continuously increasing demand for innovative and robust solutions for energy-efficient air purification.

### SUMMARY

In an embodiment, the present disclosure provides a component for a filter unit includes a nozzle element having a first diameter adjacent the filter unit, where the nozzle element has a second diameter, the second diameter being larger than the first diameter so that a resistance to an air flow from the filter unit is reduced by the nozzle element. The component for the filter unit includes an air-guide element configured to at least partially accelerate an air pulse into the filter unit in order to increase a cleaning performance in the filter unit.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

Exemplary embodiments of the invention are described in detail in the following with reference to the accompanying drawings, in which:

FIGS. 1 and 2 show a component in accordance with an embodiment;

FIG. 3 shows a filter unit in accordance with an embodiment;

FIG. 4 shows a component in accordance with an embodiment; and

FIG. 5 shows an air purification system in accordance with an embodiment.

### DETAILED DESCRIPTION

Embodiments of the invention can advantageously provide an improved component for a filter unit.

An embodiment of the present disclosure provides that the cleaning performance can be improved by the acceleration of the air pulse. This is because particles or the like which have settled in the filter element can be removed by the air pulse in a direction opposite to the air flow. This effect can be enhanced by accelerating the air pulse. Another advantage of the present disclosure is that the component can be attached to or retrofitted to existing filter units, which can thus be modified at a reasonable cost in order to avoid prolonged downtimes and achieve low pressure drops. In addition, better cleaning combined with low pressure drops can be achieved during normal operation, which can increase the service life of the filter unit and reduce the overall cost of operating the filter unit.

An embodiment of the present disclosure includes that the component for a filter unit includes a nozzle element having a first diameter adjacent the filter unit, the nozzle element having a second diameter, the second diameter being larger than the first diameter, so that a resistance to an air flow from the filter unit is reduced by the nozzle element. Furthermore, the component has an air-guide element configured to at least partially accelerate an air pulse into the filter unit in order to increase a cleaning performance of the filter unit.

In other words, the air flow passes through a filter element and along a first direction through the component, the flow resistance in the first direction being reduced by means of the nozzle element. Further preferably, the filter element of the filter unit can be cleaned by means of an air pulse in a second direction substantially opposite to the first direction, the air-guide element being capable of accelerating the air pulse so as to further increase a cleaning performance of the filter unit. Preferably, a static pressure at the nozzle inlet can be reduced so that a maximum amount of secondary air is drawn in order to improve the cleaning performance of the filter unit. For example, air can flow through the filter element and exit the interior of the filter through the component. During such exiting through the component, energy losses can occur, mainly due to vortex formation at the outlet. By matching the second diameter to the first diameter of the component, the flow can better follow the geometry, so that the outlet diameter will be larger for a given volumetric flow rate and thus the exit velocity will decrease, making it possible to achieve a lower energy loss. For example, the first diameter may be located at an end of the component adjacent the filter unit, and the second diameter may be located at an opposite end of the component. Moreover, the air-guide element of the component is configured such that the cleaning performance is also enhanced in the case of the air pulse. The bell-mouth shape for improving the resistance to the air flow through the component can result in a larger portion of the incident free jet, which can provide the air pulse, being captured. The air pulse can be accelerated by flowing into the nozzle element. In particular, the air-guide element may be located in the air pulse, so that the flow can be further accelerated. Further preferably, the component may be made in one piece, for example, by injection molding of plastic material, so that the nozzle element and the air-guide element are formed during the molding of the component.

Further preferably, the air-guide element divides the nozzle element into a first region between the nozzle element and the air-guide element and a second region within the air-guide element, the air-guide element being configured to accelerate the air pulse in the second region, the nozzle element being configured to draw in ambient air in the first region based on the accelerated air pulse in order to further increase the cleaning performance of the filter unit.

One advantage of this embodiment is that the acceleration of the air pulse and the resulting reduction in static pressure create a secondary flow in the first region, so that additional air can be introduced into the interior of the filter unit to thereby further increase the cleaning performance of the filter unit.

Further preferably, the nozzle element preferably has a first venting area depending on the first diameter, the nozzle element having a second venting area depending on the second diameter, the air-guide element having a third venting area located at the end of the air-guide element opposite the filter unit, a combination of the second venting area and the third venting area being larger than the first venting area.

One advantage of this embodiment is that, although the venting area in the nozzle element is reduced by the installation of the air-guide element and possible webs, the volume flow from the filter unit through the component is not interfered with thanks to the addition of the third venting area.

Further preferably, the third venting area is offset relative to the second venting area along an axis of rotation of the nozzle element in order to increase an area of the combination.

One advantage of this embodiment is that, by offsetting the third venting area relative to the second venting area along the axis of rotation, the extension width of the component does not need to increase in order to increase the combination of the second and third venting areas.

Further preferably, a ratio of the combination of the second venting area and the third venting area to the first venting area is adapted to reduce a resistance to an air flow from the filter unit.

One advantage of this embodiment is that the ratio can be selected such that the space required for the component remains small, but at the same time the resistance to flow remains low, in order to thereby maintain the combination within an optimal ratio to the first air passage area.

Preferably, the air-guide element has a fourth venting area, the fourth venting area facing the filter unit, the fourth venting area substantially being smaller than the third venting area, so that the air pulse is accelerated by the air-guide element.

One advantage of this embodiment is that the tapered contour of the air-guide element allows the air pulse to be focused into the center of the filter element in order to thereby achieve uniform cleaning performance in the filter element.

Further preferably, the component has at least one clip element, the clip element being adapted to at least partially engage with the filter unit to secure the component to the filter unit.

One advantage of this embodiment is that the clip element allows the component to be easily retrofitted to existing systems. Further preferably, the clip element may have a flow-optimized cross-section or shape so that the arrangement of the clip may further improve the guidance of the air impulse and/or air flow within the component. In particular, the shape of the clip element may further reduce separation of the flow at the edges of the component. This also reduces the integrated pressure drop, thereby increasing the potential service life of the filter.

Preferably, the air-guide element is configured to substantially completely receive the air pulse originating from a valve assembly.

One advantage of this embodiment may be that a free jet in the form of an air pulse originating from the valve assembly is substantially completely received by the air-guide element owing to the fact that the air guide element is configured to capture the free jet, at least at its end opposite the filter unit.

Further preferably, the air-guide element is mounted to the nozzle element via at least one web.

One advantage of this embodiment is that the air-guide element can be held in a predetermined position within the nozzle element to thereby further reduce the air resistances.

Further preferably, the web is adapted to reduce turbulence of the air flow within the nozzle element.

One advantage of this embodiment is that a cross-sectional area of the web or the like can be adapted to further reduce the air resistance within the nozzle element to thereby prevent turbulence or the like.

Further preferably, the component includes a predetermined region having a plurality of contour elements in a predetermined pattern, the plurality of contour elements being adapted to create a turbulent boundary layer in order to reduce a flow resistance of the predetermined region.

One advantage of this embodiment is that the plurality of recesses allows a turbulent boundary layer to be created between the component and the air flow within the nozzle element to thereby further reduce the air resistances or to ensure that the air flow adheres longer to the surface of the nozzle element.

Further preferably, the predetermined region is at least partially located on the nozzle element, the air-guide element, the clip element, and/or the web.

One advantage of this embodiment is that, depending on the respective region, such as the nozzle element, the plurality of contour elements can be adapted accordingly to thereby further reduce the flow resistance.

Further preferably, the plurality of contour elements each include a substantially spherical recess, the plurality of contour recesses, in conjunction with the predetermined pattern, being adapted to form a golf ball structure.

Another aspect of the present disclosure relates to a filter unit including a component as described above and below as well as a filter element adapted to filter a predetermined selection of elements out of an air flow, the component being adapted to reduce a resistance to the air flow through the filter unit, the component being adapted to accelerate an air pulse onto the component in order to clean the filter element.

One advantage of this embodiment is that the maximum operating time of the filter element in the filter unit can be further increased by the improved cleaning performance of the filter element.

A further aspect of the present disclosure relates to an air purification system including a component as described above and below and/or a filter unit as described above and below.

It should also be noted that the term “unit” as used herein is to be understood broadly and includes both single-piece and multi-piece designs of the respective units, and that the respective sub-units do not have to be provided at a single position on the filter unit or air purification system, but may also be provided in a distributed manner on the filter unit or on the air purification system.

All disclosures described above and below with respect to one aspect of the present disclosure apply equally to all other aspects of the present disclosure.

The figures are merely schematic and are not true-to-scale. In the figures, identical, identically acting, or similar elements are designated using the same reference numerals.

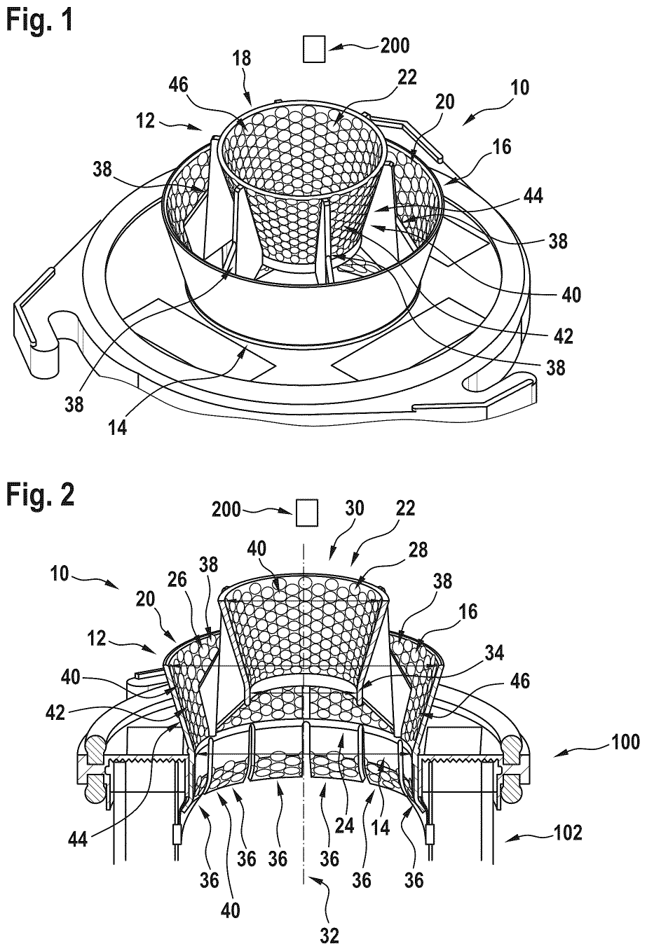

FIG. 1 shows a component 10 for a filter unit 100, the component 10 including a nozzle element 12 having a first diameter 14 adjacent filter unit 100, the nozzle element 12 having a second diameter 16, the second diameter 16 being larger than the first diameter 14, so that a resistance to an air flow from the filter unit 100 is reduced by nozzle element 12. Furthermore, component 10 has an air-guide element 18 configured to at least partially accelerate an air pulse into filter unit 100 in order to increase a cleaning performance of filter unit 100.

As can also be seen in FIG. 1, a valve assembly 200 may be disposed above component 10. Valve assembly 200 is capable of emitting an air pulse, which is accelerated by air-guide element 18. Furthermore, air-guide element 18 may divide nozzle element 12 into a first region 20 and a second region 22. Preferably, first region 20 is formed between air-guide element 18 and nozzle element 12. Second region 22 is preferably located within air-guide element 18. Preferably, air-guide element 18 may be mounted to nozzle element 12 or component 10 via a plurality of webs 38. Preferably, air-guide element 18 and the inner surface of nozzle element 12 have a plurality of contour elements 42 in a predetermined region 40, the contour elements 42 being arranged in a predetermined pattern to thereby form, for example, a golf ball structure.

FIG. 2 shows a component 10 in accordance with an embodiment. In FIG. 2, component 10 is shown in a sectional view to further illustrate the principle of operation of component 10. Component 10 includes a nozzle element 12 having a first diameter 14 and a second diameter 16. Second diameter 16 is larger than first diameter 14. Air-guide element 18 is at least partially located within nozzle element 12. Furthermore, air-guide element 18 preferably divides nozzle element 12 into a first region 20 and a second region 22. First region 20 is preferably located between nozzle element 12 and air-guide element 18. Second region 22 is located within air-guide element 18. Preferably, second region 22 of air-guide element 18 is configured to be able to accelerate the air pulse. This is achieved, for example, by air-guide element 18 forming a funnel. The air pulse exiting from air-guide element 18 provides an at least temporary negative pressure in first region 20, so that the air pulse, which has been accelerated, can introduce ambient air through first region 20 into filter element 102 of the filter unit.

Preferably, first diameter 14 of component 10 provides a first venting area 24, as illustrated in FIG. 2. As shown in FIG. 2, this venting area may be circular. Furthermore, second diameter 16 provides a second venting area 26, which may also be circular. Preferably, air-guide element 18 has a third venting area 28, which is located at the end 30 of air-guide element 18 opposite filter unit 100. Preferably, the combination of second venting area 26 and third venting area 28 is larger than first venting area 24.

The enlargement of the combination relative to first venting area 24 can be achieved in particular by an offset of third venting area 28 relative to second venting area 26 along an axis of rotation 32 of nozzle element 12.

As shown in FIG. 2, a ratio of the combination of second venting area 26 and third venting area 28 to first venting area 24 is adapted to reduce a resistance to an air flow from the filter unit.

Preferably, air-guide element 18 may have a fourth venting area 34, the fourth venting area 34 facing filter unit 100, the fourth venting area 34 substantially being smaller than third venting area 28, so that the air pulse is accelerated by air-guide element 18. As shown in FIG. 2, air-guide element 18 may be funnel-shaped, so that venting area 34 is larger than third venting area 28. Preferably, component 10 may have a plurality of clip elements 36 for securing the component to filter unit 100. Further preferably, air-guide element 18 may be shaped according to a valve assembly 200, so that air-guide element 18 is configured to substantially completely receive the air pulse originating from valve assembly 200.

Further preferably, air-guide element 18 is mounted to nozzle element 12 via a web 38, the web 38 being adapted to reduce turbulence of the air flow within nozzle element 12.

Further preferably, component 10 includes a predetermined region 40, a plurality of contour elements 42 being arranged in predetermined region 40 in a predetermined pattern 44 in order to create a turbulent boundary layer, thereby making it possible to reduce the flow resistance of predetermined region 40.

Further preferably, predetermined region 40 is at least partially located on nozzle element 12, air-guide element 18, clip element 36, and/or web 38. Preferably, as shown in FIG. 2, both nozzle element 12 and clip elements 36, as well as the inner and outer surfaces of air guide element 18, have the predetermined region 40 with the plurality of contour elements 42.

Further preferably, as shown in FIG. 2, the plurality of contour elements 42 are configured as substantially spherical recesses 46 to form a golf ball structure in conjunction with predetermined pattern 44.

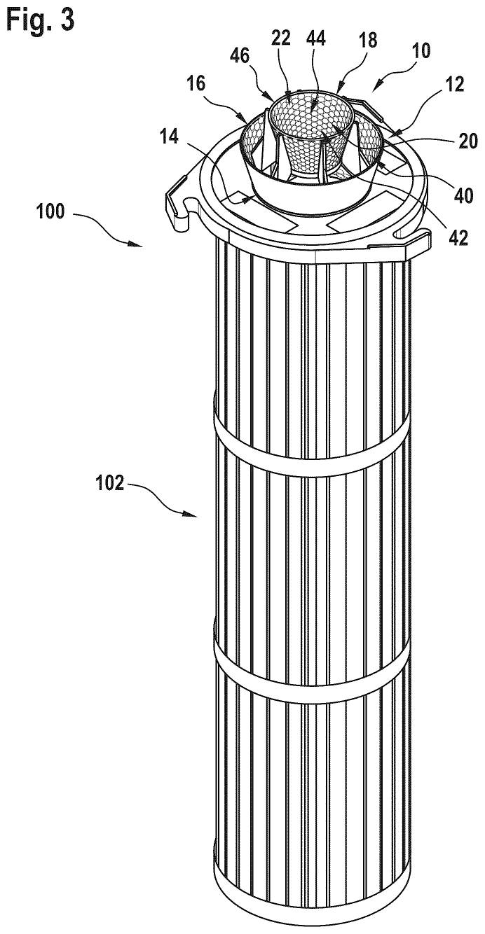

FIG. 3 shows a filter unit 100 in accordance with an embodiment. Filter unit 100 includes a component 10 as described above and below as well as a filter element 102 adapted to filter a predetermined selection of elements out of an air flow, the component 10 being adapted to reduce a resistance to the air flow through the through filter unit 100, the component 10 being adapted to accelerate an air pulse onto component 10 in order to clean filter element 102.

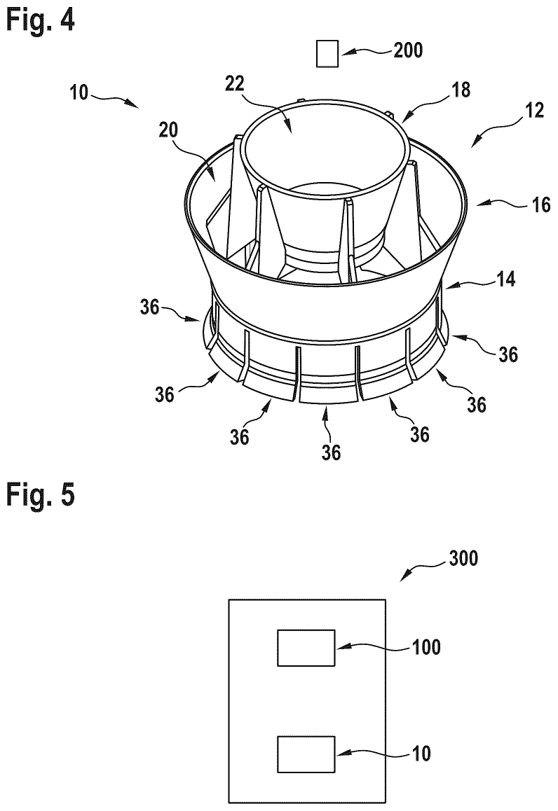

FIG. 4 shows a component 10 in accordance with an embodiment. Component 10 includes a nozzle element 12 as well as an air-guide element 18 at least partially located within nozzle element 12. Preferably, an air pulse originating from a valve assembly 200 can be accelerated by air-guide element 18 to improve a cleaning performance in a filter unit 100. Air-guide element 18 may preferably form a first region 20 a second region 22, the first region 20 being located between nozzle element 12 and air-guide element 18 and the second region 22 being located within the air-guide element. Preferably, the air pulse originating from valve assembly 200 can be substantially completely introduced into second region 22 in order to accelerate it further. The acceleration of the air pulse allows ambient air to be drawn in through first region 20. Further preferably, clip elements 36 of component 10 can at least partially engage with a filter unit 100, so that component 10 can be easily retrofitted.

FIG. 5 shows an air purification system 300 in accordance with an embodiment. Air purification system 300 includes a component 10 as described above and below and/or a filter unit 100 as described above and below.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A component for a filter unit, comprising:
a nozzle element having a first diameter adjacent the filter unit, the nozzle element having a second diameter, the second diameter being larger than the first diameter so that a resistance to an air flow from the filter unit is reduced by the nozzle element; and
an air-guide element configured to at least partially accelerate an air pulse into the filter unit in order to increase a cleaning performance in the filter unit.

2. The component as recited in claim 1, wherein the air-guide element divides the nozzle element into a first region between the nozzle element and the air-guide element and a second region within the air-guide element, the air-guide element being configured to accelerate the air pulse in the second region, the nozzle element being configured to draw in ambient air in the first region based on the accelerated air pulse in order to increase the cleaning performance of the filter unit.

3. The component as recited in claim 1, wherein the nozzle element has a first venting area depending on the first diameter, the nozzle element having a second venting area depending on the second diameter, the air-guide element having a third venting area located at an end of the air-guide element opposite the filter unit, wherein a combination of the second venting area and the third venting area being larger than the first venting area.

4. The component as recited in claim 3, wherein the third venting area is offset relative to the second venting area along an axis of rotation of the nozzle element in order to increase an area of the combination.

5. The component as recited in claim 3, wherein a ratio of the combination of the second venting area and the third the venting area to the first venting area is adapted to reduce the resistance to the air flow from the filter unit.

6. The component as recited in claim 3, wherein the air-guide element has a fourth venting area, the fourth venting area facing the filter unit, the fourth venting area being smaller than the third venting area so that the air pulse is accelerated by the air-guide element.

7. The component as recited in claim 1, wherein the component has at least one clip element, the clip element being adapted to at least partially engage with the filter unit to secure the component to the filter unit.

8. The component as recited in claim 1, wherein the air-guide element is configured to completely receive the air pulse originating from a valve assembly.

9. The component as recited in claim 1, wherein the air-guide element is mounted to the nozzle element via at least one web.

10. The component as recited in claim 9, wherein the at least one web is adapted to reduce turbulence of the air flow within the nozzle element.

11. The component as recited in claim 1, wherein a predetermined region on the component has a plurality of contour elements in a predetermined pattern, the plurality of contour elements being adapted to create a turbulent boundary layer in order to reduce a flow resistance of the predetermined region.

12. The component as recited in claim 11, wherein the predetermined region is at least partially located on the nozzle element, the air-guide element, a clip element, and/or a web.

13. The component as recited in claim 11, wherein the plurality of contour elements each include a spherical recess, the plurality of recesses, in conjunction with the predetermined pattern, being adapted to form a golf ball structure.

14. A filter unit comprising:
a component according to claim 1; and
a filter element adapted to filter a predetermined selection of elements out of the air flow, the component being adapted to reduce the resistance to the air flow through the through filter unit, the component being adapted to accelerate the air pulse onto the component in order to clean the filter element.

15. An air purification system comprising a component according to claim 1.
